(19) United States
(12) Patent Application Publication
(10) Pub. No.: US 2022/0271323 A1
(43) Pub. Date: Aug. 25, 2022

(54) DEGASSING DEVICE FOR PREPARING SECONDARY BATTERY

(71) Applicant: CLEVER CO., LTD., Chungcheongbuk-do (KR)

(72) Inventors: Jong Hong JEONG, Chungcheongbuk-do (KR); Sang Jin KIM, Daejeon Metropolitan City (KR)

(21) Appl. No.: 17/629,555

(22) PCT Filed: Jul. 24, 2020
(86) PCT No.: PCT/KR2020/009809

§ 371 Date: Apr. 14, 2022

(30) Foreign Application Priority Data
Jul. 24, 2019 (KR) 10-2019-0089877

(51) Int. Cl. H01M 10/04; H01M 50/342; H01M 50/367

(52) U.S. Cl. CPC H01M 10/0404; H01M 10/0481; H01M 50/3425; H01M 50/367

(57) ABSTRACT

Disclosed is a degassing device for preparing a secondary battery, the degassing device including a piercing chamber configured to accommodate a first amount of degassing target pouches and having an internal space in which a pressure is selectively controlled to a vacuum pressure or an atmospheric pressure, the piercing chamber including a piercing unit configured to form inner gas discharge paths in the first amount of degassing target pouches, a first buffer chamber having an internal pressure maintained as the vacuum pressure and configured to accommodate the first amount of degassing target pouches unloaded from the piercing chamber, a sealing chamber having an internal pressure maintained as the vacuum pressure and having a sealing unit configured to receive the first amount of degassing target pouches accommodated in the first buffer chamber while sequentially receiving a second amount of degassing target pouches smaller than the first amount of degassing target pouches.

### TECHNICAL FIELD

The present disclosure relates to a degassing device for preparing a secondary battery, and more particularly, to a degassing device for preparing a secondary battery, which is capable of increasing a degassing process speed while improving efficiency in removing gas produced in a secondary battery pouch.

### BACKGROUND ART

This section provides background information related to the present disclosure which is not necessarily prior art.

A process of manufacturing a general pouch-type secondary battery is broadly classified into three processes including an electrode production process, an assembly process, and a charging/discharging process.

The electrode production process manufactures electrode assemblies using positive plates, negative plates, and separators, and the electrode assemblies serve as batteries.

When the assembly process of inputting the manufactured electrode assembly and an electrolyte into a pouch-type encapsulant is completed, a basic shape and a basic function of a secondary battery are implemented.

The secondary battery manufactured through the assembly process is repeatedly charged and discharged, finally tested, and then shipped.

The charging/discharging process activates the electrode assembly by charging and discharging the completely assembled pouch-type secondary battery, and the defective products may be sorted during the charging/discharging process.

In this case, gas is produced in a pouch by a chemical reaction between the electrode and the electrolyte, and the gas increases a pressure in the pouch.

The produced gas contains hydrogen fluoride (HF), which is generated when lithium hexafluorophosphate contained in the electrolyte meets water, and gas generated by vaporization of the electrolyte.

A process of removing the gas in the pouch is called a degassing process.

The degassing process, which is also called a deaeration process, is one of the essential processes that need to be performed to ship normal secondary battery products.

Because the gas, which is removed by the degassing process, contains gas harmful to a human body, the degassing process needs to be performed in a state in which a degassing target pouch is accommodated in a chamber sealed from the outside.

The degassing process includes a piercing process of forming a discharge path for the gas, a discharge process of discharging the gas through the discharge path, and a sealing process of sealing the pouch again.

Among the processes, the discharge process may be performed through an evacuation process performed on the pierced secondary battery by using a chamber under a reduced-pressure atmosphere or a pressing process of directly pressing the secondary battery.

In this case, the electrolyte in the pouch may also be discharged during the discharge process.

That is, not only the gas but also the electrolyte may be discharged when the piercing is performed in the fully depressurized chamber, a speed of depressurizing the chamber is excessively high, or a pressure in the pressing process is excessively high.

For this reason, the degassing process in the related art has a fatal limitation in increasing a speed of performing the process.

In addition, during the degassing process in the related art, the piercing, discharging, and sealing processes are performed in a single chamber. For this reason, there is a limitation in number of pouches to be processed per unit time in the degassing process.

In addition, to unload the pouch from the chamber, the chamber needs to be opened after a pressure in the chamber is adjusted to the atmospheric pressure in a state in which the gas is discharged from the pouch through the evacuation process.

During the process of adjusting the pressure in the chamber to the atmospheric pressure, the gas remains in the chamber without being discharged to the outside of the chamber, which causes a problem in that the harmful gas leaks into the atmosphere when the chamber is opened.

### SUMMARY

### Technical Problem

An object of the present disclosure is to provide a degassing device for preparing a secondary battery, which is capable of increasing a degassing process speed while improving efficiency in removing gas produced in a secondary battery pouch.

Another object of the present disclosure is to provide a degassing device for preparing a secondary battery, which is equipped with chambers configured to independently perform a piercing process, a sealing process, and a discharge process, thereby shortening a degassing process time while enabling slow evacuation that ensures a sufficient evacuation time for which gas is discharged from a pouch.

### Technical Solution

This section provides a general summary of the disclosure and is not a comprehensive disclosure of its full scope or all of its features.

One aspect of the present disclosure provides a degassing device for preparing a secondary battery, the degassing device including: a piercing chamber configured to accommodate a first amount of degassing target pouches and having an internal space in which a pressure is selectively controlled to a vacuum pressure or an atmospheric pressure, the piercing chamber including a piercing unit configured to form inner gas discharge paths in the first amount of degassing target pouches; a first buffer chamber having an internal pressure maintained as the vacuum pressure and configured to accommodate the first amount of degassing target pouches unloaded from the piercing chamber; a sealing chamber having an internal pressure maintained as the vacuum pressure and having a sealing unit configured to receive the first amount of degassing target pouches accommodated in the first buffer chamber while sequentially receiving a second amount of degassing target pouches smaller than the first amount of degassing target pouches, the sealing unit configured to seal the first amount of degassing target pouches; a second buffer chamber having an internal pressure maintained as the vacuum pressure and configured to sequentially receive and accommodate the second amount of degassing target pouches from the sealing chamber; and an unloading chamber configured to receive and accommodate the first amount of degassing target pouches from the second buffer chamber and having an internal space in which a pressure is selectively controlled to the vacuum pressure or the atmospheric pressure.

In the degassing device for preparing a secondary battery according to one aspect of the present disclosure, the piercing chamber may include: a loading gate disposed at one side and configured such that the first amount of degassing target pouches is loaded therethrough; a first partition door disposed at the other side and configured to be openable and closable and separate the piercing chamber and the first buffer chamber; and a first pressure adjustment unit configured to control a pressure in the internal space, and a process of forming the inner gas discharge path by the piercing unit and a process of reducing the pressure in the internal space to a preset vacuum pressure may be performed for an amount of time equal to or larger than a sealing time required to seal the first amount of degassing target pouches through the sealing chamber.

In the degassing device for preparing a secondary battery according to one aspect of the present disclosure, inert gas may be injected into the internal space before the inner gas discharge path is formed by the piercing unit.

In the degassing device for preparing a secondary battery according to one aspect of the present disclosure, the sealing time may be 4 to 6 minutes, and the vacuum pressure may be 10 torr.

In the degassing device for preparing a secondary battery according to one aspect of the present disclosure, the unloading chamber may include: an unloading gate disposed at one side and configured such that the first amount of degassing target pouches is unloaded therethrough; a fourth partition door disposed at the other side and configured to be openable and closable and separate the second buffer chamber and the unloading chamber; and a second pressure adjustment unit configured to control a pressure in an unloading space defined by the unloading gate and the fourth partition door.

The degassing device for preparing a secondary battery according to one aspect of the present disclosure may include: a second partition door configured to be openable and closable and separate the first buffer chamber and the sealing chamber; and a third partition door configured to be openable and closable and separate the sealing chamber and the second buffer chamber.

In the degassing device for preparing a secondary battery according to one aspect of the present disclosure, the first partition door may be opened in a state in which a pressure in the piercing chamber and a pressure in the first buffer chamber are adjusted to the preset vacuum pressure, the first partition door may be closed after the first amount of degassing target pouches is transferred from the piercing chamber to the first buffer chamber, the fourth partition door may be opened in a state in which a pressure in the second buffer chamber and a pressure in the unloading chamber are adjusted to the preset vacuum pressure, and the fourth partition door may be closed after the first amount of degassing target pouches is transferred from the second buffer chamber to the unloading chamber.

### Advantageous Effects

According to the present disclosure, the piercing process, the sealing process, and the discharge process are simultaneously performed in the independent chambers, which makes it possible to shorten the degassing process time while enabling the slow evacuation that ensures the sufficient evacuation time for which the gas is discharged from the pouch.

### BRIEF DESCRIPTION OF THE DRAWINGS

FIG. 1 is a view illustrating one embodiment of a degassing device for preparing a secondary battery according to the present disclosure.

FIG. 2 is a view illustrating another embodiment of the degassing device for preparing a secondary battery according to the present disclosure.

FIG. 3 and FIG. 4 are views illustrating a sequence of operations of the degassing device for preparing a secondary battery according to the present disclosure.

### DETAILED DESCRIPTION

Hereinafter, embodiments of a degassing device for preparing a secondary battery according to the present disclosure will be described in detail with reference to the drawings.

However, it should be noted that the intrinsic technical spirit of the present disclosure is not limited by the following exemplary embodiment, and the following exemplary embodiment may easily be substituted or altered by those skilled in the art based on the intrinsic technical spirit of the present disclosure.

In addition, the terms used herein are selected for convenience of description and should be appropriately interpreted as a meaning that conform to the technical spirit of the present disclosure without being limited to a dictionary meaning when recognizing the intrinsic technical spirit of the present disclosure.

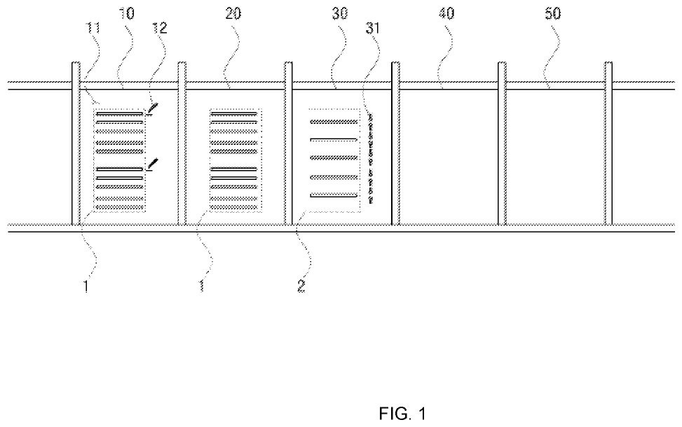

FIG. 1 is a view illustrating one embodiment of a degassing device for preparing a secondary battery according to the present disclosure.

Referring to FIG. 1, a degassing device according to the present embodiment includes a piercing chamber 10, a first buffer chamber 20, a sealing chamber 30, a second buffer chamber 40, and an unloading chamber 50.

The piercing chamber 10 accommodates a first amount of degassing target pouches 1, and a pressure in the internal space 11 is selectively controlled to a vacuum pressure or an atmospheric pressure. In addition, the piercing chamber 10 includes a piercing unit 12 configured to form inner gas discharge paths in the first amount of degassing target pouches 1.

The internal pressure of the first buffer chamber 20 is maintained as the vacuum pressure, and the first buffer chamber 20 accommodates the first amount of degassing target pouches 1 unloaded from the piercing chamber 10.

The internal pressure of the sealing chamber 30 is maintained as the vacuum pressure, and the sealing chamber 30 includes a sealing unit 31 configured to receive the first amount of degassing target pouches 1 accommodated in the first buffer chamber 20 while sequentially receiving a second amount of degassing target pouches smaller than the first amount of degassing target pouches 1, the sealing unit 31 being configured to seal the degassing target pouches.

The internal pressure of the second buffer chamber 40 is maintained as the vacuum pressure, and the second buffer chamber 40 sequentially receives and accommodates a second amount of degassing target pouches 2 from the sealing chamber 30.

The unloading chamber 50 receives and accommodates the first amount of degassing target pouches 1 from the second buffer chamber 40, and the pressure of the internal space of the unloading chamber 50 is selectively controlled to the vacuum pressure or the atmospheric pressure.

According to the degassing device for preparing a secondary battery according to the present disclosure, the piercing and evacuation processes in the piercing chamber 10, the sealing process in the sealing chamber 30, and the unloading process in the unloading chamber 50 are simultaneously performed.

That is, the sub-processes of the piercing process, the evacuation process, and the sealing process are performed in the different chambers. Since the sub-processes are performed in parallel for a particular working time, it is possible to lengthen the time required to perform the evacuation process.

Since the time required to perform the evacuation process is lengthened, it is possible to prevent the electrolyte from leaking during the gas discharge process.

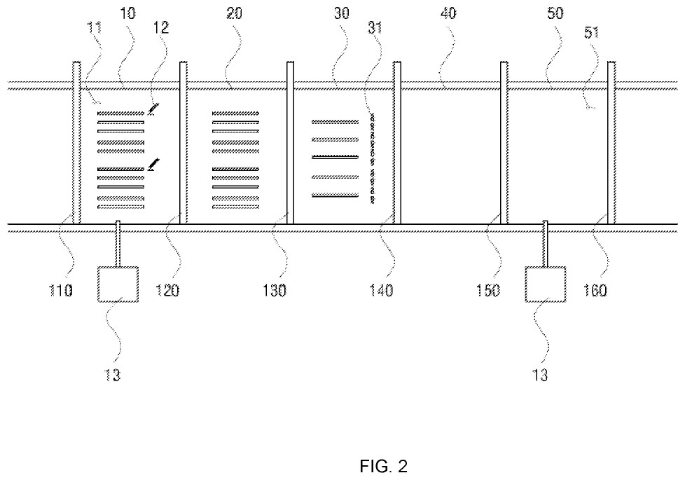

FIG. 2 is a view illustrating another embodiment of the degassing device for preparing a secondary battery according to the present disclosure.

Referring to FIG. 2, in the degassing device for preparing a secondary battery according to the present embodiment, the piercing chamber 10 includes a loading gate 110, a first partition door 120, and a first pressure adjustment unit 13.

The loading gate 110 is disposed at one side of the piercing chamber and opened or closed while defining a passageway through which the first amount of degassing target pouches 1 is loaded.

The first partition door 120 is disposed at the other side of the piercing chamber and configured to be openable and closable and separate the piercing chamber 10 and the first buffer chamber 20.

The first pressure adjustment unit 13 controls the pressure in the internal space 11.

In the degassing device for preparing a secondary battery according to the present embodiment, the process of forming the inner gas discharge path by the piercing unit 12 and the process of reducing the pressure in the internal space 11 to a preset vacuum pressure are performed for an amount of time equal to or larger than a sealing time required to seal the first amount of degassing target pouches 1 through the sealing chamber 30.

In addition, in the degassing device for preparing a secondary battery according to the present embodiment, the unloading chamber 50 includes an unloading gate 160 disposed at one side of the unloading chamber 50 and configured such that the first amount of degassing target pouches 1 is unloaded therethrough.

In addition, in the degassing device for preparing a secondary battery according to the present embodiment, the unloading chamber 50 includes a fourth partition door 150 disposed at the other side of the unloading chamber 50 and configured to be openable and closable and separate the second buffer chamber 40 and the unloading chamber 50.

In addition, in the degassing device for preparing a secondary battery according to the present embodiment, the unloading chamber 50 includes a second pressure adjustment unit 52 configured to control a pressure in an unloading space 51 defined by the unloading gate 160 and the fourth partition door 150.

In addition, the degassing device for preparing a secondary battery according to the present embodiment includes a second partition door 130 configured to be openable and closable and separate the first buffer chamber 20 and the sealing chamber 30, and a third partition door 140 configured to be openable and closable and separate the sealing chamber 30 and the second buffer chamber 40.

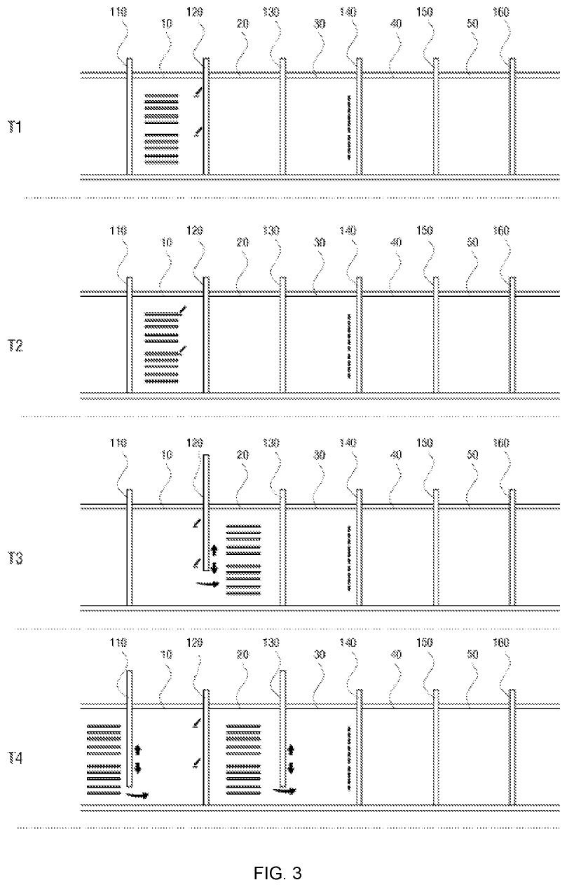

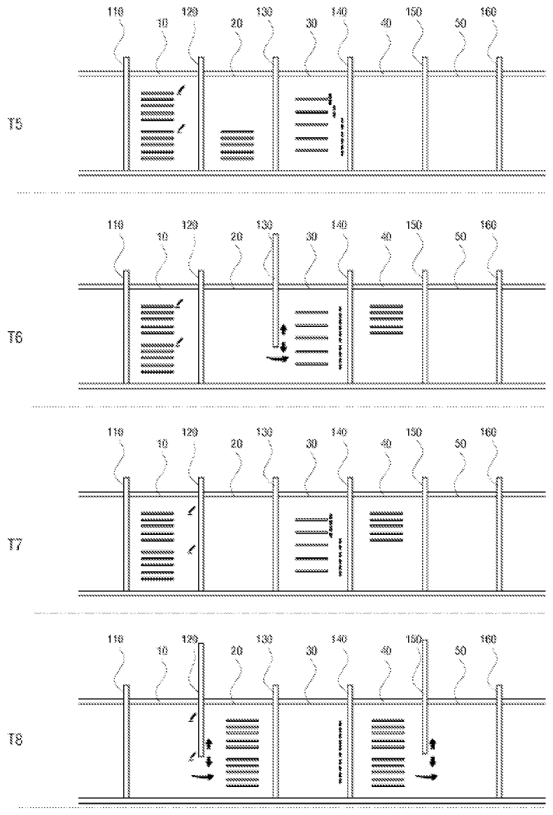

FIGS. 3 to 4 are views illustrating a sequence of operations of the degassing device illustrated in FIG. 1.

In piercing and evacuation steps T1 and T2, the process of forming the discharge paths in the first amount of degassing target pouches 1 and the evacuation process of reducing the pressure in the piercing chamber 10 are performed.

When the evacuation process is completed, a first buffer transfer step T3 of transferring the first amount of degassing target pouches 1 to the first buffer chamber 20 is performed.

When the first partition door 120 is closed, the second partition door 130 is opened, and the second amount of degassing target pouch 2 included in the first amount of degassing target pouch 1 is transferred to the sealing chamber 30 (T4).

In this case, as the loading gate 110 is opened, another first amount of degassing target pouches 1 is loaded into the piercing chamber 10.

When the sealing chamber 30 and the loading gate 110 are closed, the piercing and evacuation processes and the sealing process begin to be simultaneously performed.

Since the piercing and evacuation processes are performed while the sealing process is performed (T4 to T7), the evacuation process may be performed slowly.

As a result, in the degassing device for preparing a secondary battery according to the present embodiment, the process of forming the inner gas discharge path in another first amount of degassing target pouches 1 by the piercing unit 12 and the process of reducing the pressure in the internal space 11 of the piercing chamber 10 to a preset vacuum pressure are performed for an amount of time equal to or larger than the sealing time required to seal the first amount of degassing target pouches 1 through the sealing chamber 30.

In addition, inert gas may be injected into the internal space 11 before the inner gas discharge path is formed by the piercing unit 12.

When the electrolyte comes into contact with the moisture in the atmosphere through the piercing process, a reaction occurs, which produces a material that degrades the performance of the secondary battery. To solve this problem, inert gas (Ar, He, etc.) is injected into the internal space 11 before the piercing process is performed.

In addition, when the inert gas is periodically supplied even during the evacuation process, it is possible to obtain an effect of increasing the evacuation speed.

Specifically, the evacuation speed decreases as the pressure in the internal space 11 decreases. A process of discharging the injected inert gas again may solve the situation in which the evacuation speed decreases.

In the degassing device for preparing a secondary battery according to the present embodiment, the sealing time is particularly 4 to 6 minutes, and the vacuum pressure is 10 torr.

In addition, in the degassing device for preparing a secondary battery according to the present embodiment, the first partition door 120 is opened in the state in which the pressure in the piercing chamber 10 and the pressure in the first buffer chamber 20 are adjusted to the preset vacuum pressure. The first partition door 120 is closed after the first amount of degassing target pouches 1 is transferred from the piercing chamber 10 to the first buffer chamber 20.

In addition, in the degassing device for preparing a secondary battery according to the present embodiment, the fourth partition door 150 is opened in the state in which the pressure in the second buffer chamber 40 and the pressure in the unloading chamber 50 are adjusted to the preset vacuum pressure. The fourth partition door 150 is closed after the first amount of degassing target pouches 1 is transferred from the second buffer chamber 40 to the unloading chamber 50.

1. A degassing device for preparing a secondary battery, the degassing device comprising:
a piercing chamber configured to accommodate a first amount of degassing target pouches and having an internal space in which a pressure is selectively controlled to a vacuum pressure or an atmospheric pressure, the piercing chamber including a piercing unit configured to form inner gas discharge paths in the first amount of degassing target pouches;
a first buffer chamber having an internal pressure maintained as the vacuum pressure and configured to accommodate the first amount of degassing target pouches unloaded from the piercing chamber;
a sealing chamber having an internal pressure maintained as the vacuum pressure and having a sealing unit configured to receive the first amount of degassing target pouches accommodated in the first buffer chamber while sequentially receiving a second amount of degassing target pouches smaller than the first amount of degassing target pouches, the sealing unit configured to seal the first amount of degassing target pouches;
a second buffer chamber having an internal pressure maintained as the vacuum pressure and configured to sequentially receive and accommodate the second amount of degassing target pouches from the sealing chamber; and
an unloading chamber configured to receive and accommodate the first amount of degassing target pouches from the second buffer chamber and having an internal space in which a pressure is selectively controlled to the vacuum pressure or the atmospheric pressure.

2. The degassing device of claim 1, wherein the piercing chamber comprises:
a loading gate disposed at one side and configured such that the first amount of degassing target pouches is loaded therethrough;
a first partition door disposed at the other side and configured to be openable and closable and separate the piercing chamber and the first buffer chamber; and
a first pressure adjustment unit configured to control a pressure in the internal space, and
wherein a process of forming the inner gas discharge path by the piercing unit and a process of reducing the pressure in the internal space to a preset vacuum pressure are performed for an amount of time equal to or larger than a sealing time required to seal the first amount of degassing target pouches through the sealing chamber.

3. The degassing device of claim 2, wherein inert gas is injected into the internal space before the inner gas discharge path is formed by the piercing unit.

4. The degassing device of claim 2, wherein the sealing time is 4 to 6 minutes, and the vacuum pressure is 10 torr.

5. The degassing device of claim 2, wherein the unloading chamber comprises:
an unloading gate disposed at one side and configured such that the first amount of degassing target pouches is unloaded therethrough;
a fourth partition door disposed at the other side and configured to be openable and closable and separate the second buffer chamber and the unloading chamber; and
a second pressure adjustment unit configured to control a pressure in an unloading space defined by the unloading gate and the fourth partition door.

6. The degassing device of claim 5, comprising:
a second partition door configured to be openable and closable and separate the first buffer chamber and the sealing chamber; and
a third partition door configured to be openable and closable and separate the sealing chamber and the second buffer chamber.

7. The degassing device of claim 5, wherein the first partition door is opened in a state in which a pressure in the piercing chamber and a pressure in the first buffer chamber are adjusted to the preset vacuum pressure, the first partition door is closed after the first amount of degassing target pouches is transferred from the piercing chamber to the first buffer chamber, the fourth partition door is opened in a state in which a pressure in the second buffer chamber and a pressure in the unloading chamber are adjusted to the preset vacuum pressure, and the fourth partition door is closed after the first amount of degassing target pouches is transferred from the second buffer chamber to the unloading chamber.
